(19) United States
(12) Patent Application Publication
(10) Pub. No.: US 2005/0037221 A1
(43) Pub. Date: Feb. 17, 2005

(54) Penetration improvement of copper amine solutions into dried wood by addition of carbon dioxide

(76) Inventors: Roger F. Fox, Fayetteville, GA (US); Eugene A. Pasek, Ravenna, OH (US); Phillip F. Schneider, Decatur, GA (US); Jayesh P. Patel, Stone Mountain, GA (US)

Correspondence Address: SMITH, GAMBRELL & RUSSELL, LLP;SUITE 3100, PROMENADE II, 1230 PEACHTREE STREET, N.E., ATLANTA, GA, 30309-3592, US

(21) Appl. No.: 10/915,247

(22) Filed: Aug. 10, 2004

Related U.S. Application Data
(63) Continuation-in-part of application No. 10/631,280, filed on Jul. 31, 2003.
(60) Provisional application No. 60/399,980, filed on Jul. 31, 2002.

(51) Int. Cl. B05D 3/12; B32B 21/00

(52) U.S. Cl. 428/541; 427/369; 427/371

(57) ABSTRACT

A method of performing an impregnating treatment on a resin-containing wood substrate using a fluid comprising the steps of providing the wood substrate, contacting the wood substrate with said fluid, and maintaining contact between the wood substrate and the fluid for a time period sufficient to obtain the desired penetration wherein the fluid is a wood protectant with carbon dioxide added thereto.

### Cross-Reference to Related Applications

This application claims the benefit of priority of U.S. provisional application Ser. No. 60/399,980, filed Jul. 31, 2002, which is incorporated herein by reference.

### FIELD OF THE INVENTION

The present invention relates to a method of impregnation of a wood substrate by combining a wood protectant with carbon dioxide.

### BACKGROUND OF THE INVENTION

There are many known methods for treating wood and wood composites in order to increase the resistance to biological attack and fire. Known methods include those disclosed in U.S. Pat. Nos. 5,246,652; 4,935,457; 5,549,739; 4,076,580; 4,126,473; 4,352,719; 4,879,083; 5,763,338; 6,517,907; 6,569,540; 4,241,133; 4,622,248; and PCT Publication WO 00/09326 all of which are incorporated herein by reference.

Problems that must be addressed by wood products in some environments include preservation against one or more of termites, ants (for example, carpenter ants) and other wood-destroying insects or fungi, soft rot, and mold fungi. Examples of wood-destroying fungi and soft rot and mold fungi are: Gloeophyllum trabeum, Trametes versicolor, Paxillus panuoides, Condrostereum purpurescens, Heterobasidium annosum, Bispora effusa, Stachybotrys atra, Chaetomium globosum, Trichoderma viride, Aspergillus niger, Hormiscium spec., and Stemphylium spec. Wood products are preserved using amounts of wood preservative compounds known or believed to be effective against one or more of these organisms.

Yet another problem in the art has been how to effectively incorporate a water-borne wood preservative in a wood product, so the preservative compounds reach the interior of the product, without also incorporating a significant amount of additional water in the product. Any excess incorporated water must be dried out, using additional energy, time, equipment, factory space, and thus money. Another problem in the art is how to incorporate a water-borne preservative system into wood composite products without causing a negative impact on panel structural properties.

When a structural member is to be used for long-term exterior applications, a preservative for protecting the wood against attacks by decay fungi and insects can be added to the wood or wood particles during or before a binder blending step. Any preservative which is compatible with the adhesive system can be used, such as pentachlorophenol, creosote, chromated copper arsenate, ammoniacal copper arsenate and the like. Effective amounts of such preservatives can be added to the wood particles without producing an appreciable reduction in the structural strength of the resulting structural member.

One preservative composition for solid wood products includes an aqueous ammoniacal solution of a preservative metal compound and an organic acid. Before impregnating timber with any wood treating solution it is essential to season the timber until at least all the free water has been removed from the cell spaces. This stage of seasoning represents a moisture content of about 25%-30%, varying slightly with different species. It is not possible to inject another liquid into solid wood containing much water and splits developing as the result of the subsequent drying of the timber would expose untreated timber.

Each of the patents identified above is incorporated here by reference to provide background and contribute to the best mode, enablement, and written description of this disclosure, and particularly to disclose how to make wood and wood composite products.

### BRIEF SUMMARY OF THE INVENTION

One aspect of the invention is a wood or wood composite including wood particles, a binder, at least one wood protectant, and optionally other ingredients. The wood protectant is selected from known products and combinations thereof. The present invention is not limited to uses in which the wood is effectively preserved. Also, “preservation” is used broadly in this specification to refer to any treatment which reduces the rate of deterioration of a wood or wood composite, compared to the rate of deterioration of an analogous wood or wood composite lacking the preservative.

Another aspect of the invention is a method of contacting wood or wood particles with a protectant and carbon dioxide.

Another aspect of the invention is a method for making wood and wood composites by applying to them a wood protectant and carbon dioxide, in an amount effective: (1) to reduce the degree of swelling of the wood in the presence of moisture; (2) to at least substantially preserve the resulting wood against at least one of rot, fungi, termites, or other wood-destroying organisms; or (3) both.

Yet another aspect of the invention is a protected wood or wood composite made by the method described above.

One advantage of the present invention is that the addition of the treatment agents may improve the dimensional stability of the wood in the presence of moisture, increasing its value and the number of applications for which it is suited.

In the present specification and the attached claims the term “wood substrate” designates a substrate for the impregnation process which may typically be a shaped or partially shaped wood article, structural wood, timber, poles, etc. and may also encompass materials comprising comminuted wood such as chips or building plates etcetera.

The term “resin” denotes the high viscous liquid of lipophilic or hydrophobic character present in amounts of typically some percent by weight in most types of wood, especially in wood from coniferous trees. Such resin is a very complex mixture of various substances including relative volatile components such as terpenes, whereas the main component is a mixture of non-volatile, partly unsaturated compounds including esters and free acids. The resin forms an extremely sticky gum which is capable of undergoing a certain slow hardening when exposed to the air. The resin is normally present as small drops within the cells forming the wood structure.

Copper amine solution is useful as a wood protectant and is prepared by adding basic copper carbonate [Cu(OH)₂CuCO₃] or BCC to ethanolamine aqueous solutions. The copper to amine ratio can vary greatly, but a good working range is from about 2 to about 6 and advantageously from about 3 to about 4 moles of ethanolamine per mole of copper. For monoethanolamine (MEA), the weight ratio is almost the same from about 2 to about 6 and advantageously from about 3 to about 4 MEA by weight to 1 Cu by weight. In addition, co-biocides may be added. With the present preservative an aqueous emulsion or tebuconazole is added. In the United States the industry adds didecyldimethammonium chloride and in Europe xylogen. Essentially the United States and Europe use the same copper amine solutions.

The problem with such solutions is that penetration of the treating solution into dried wood can vary from good to very poor. It is believed this is caused by the treating solution reacting with wood chemicals as it penetrates the wood. Specifically, it is felt that the wood chemicals it reacts with are gluconuronic acids, which are sugar like molecules containing carboxylic acid functional groups. When isolated in the lab, they appear to form gum-like, sticky solids. Thus, as the treating solution is pushed into wood under pressure in the treating vessel, gluconuronic acid is first dissolved by the basic nature of the treating solution. However, as the treating solution front goes further into the wood, the acidity of the wood precipitates these materials causing closure of the wood pore structure. This, of course, reduces the preservative penetration.

### BRIEF DESCRIPTION OF THE DRAWINGS

FIG. 1 shows the penetration of a protectant with ammonium hydroxide into red pine.

FIG. 2 shows the penetration of a protectant and ammonium bicarbonate into red pine.

FIG. 3 shows the penetration of a protectant with the addition of carbon dioxide into red pine (one embodiment of the present invention).

FIG. 4 shows the penetration of a protectant with the addition of carbon dioxide and ammonia.

### DETAILED DESCRIPTION OF THE INVENTION

While the invention will be described in connection with one or more embodiments, it will be understood that the invention is not limited to those embodiments. On the contrary, the invention includes all alternatives, modifications, and equivalents as may be included within the spirit and scope of the appended claims.

It has been found that by adding carbon dioxide to these solutions (or preservative concentrates) improved penetration exists. It is thought that the carbon dioxide acts as an acid to neutralize the hydroxides in the BCC forming copper carbonate. This lowers the pH of the treating solution. The lower pH reduces glucouronic acid dissolution and therefore reduces pore plugging and improves preservative penetration.

There are two main issues with wood preservatives such as copper amine solutions, including Wolman® E. One is penetration and the second is mold. There have been much effort and time spent to overcome these issues by using different additives. After several experiments it was concluded that addition of from about 0.10 to about 1.0% CO₂ in the Wolman® concentrate or solution can improve the penetration by greater than about 10%, and in some experiments greater than about 15%. In addition the use of CO₂ reduced the pH of the solution, which provided a longer stability of mold inhibitor like K-18500. The addition of K-18500 in conjunction with OIT extends the mold control for longer time and probably at a lower cost. The addition of CO₂ provides the extra benefit of increased stability of moldicide and better penetration.

An experiment was set up to determine the amount of CO₂ needed to lower the pH of the solution to about 9.5 from the current pH of from about 10.7 to about 11.1, and the amount to which solution stability would not be an issue. The rate of CO₂ absorption was also measured by obtaining the weight increase in the PACK A vs. CO₂ loss from the cylinder.

For this experiment Wolman® E CA-B (PACK A) was prepared using two different lot of BCC in the lab. Adding different amount of CO₂ performed total of four experiments, two from each lot of BCC. Approximately 960 gm of PACK A was weighed in a beaker and placed on a scale. Another scale was used for CO₂ cylinder. CO₂ was slowly purged in with constant agitation into the Wolman® E concentrate from a cylinder using a regulator. Weight of the concentrate was taken after every five grams of CO₂ addition to determine the absorption rate by obtaining the weight increase of the concentrate pH of the solution was also measured after every five grams of CO₂ addition. These solution prepared with different loadings of CO₂ were kept in glass jar to determine the stability and pH measurement of the product over time.

In another experiment, the treating solution of Wolman® E CA-B with different pH was prepared with 50 ppm K-18500 for stability study of RH 651. RH 651 is the chlorinated part of the molecule in K-18500, which is responsible for mold control. Treating solutions with K-18500 were analyzed regularly using HPLC to determine the degradation rate of molecule.

Tables 1 to 3 show the CO₂ loss and pH changes of the solution at different loadings of CO₂. Limited amount of work suggest that less than about 8%, advantageously from about 3 to about 4% CO₂ is needed to obtain a pH of about 9.5. Adding more CO₂ will reduce the pH of the solution. However, at lower pH long-term stability of the product may be reduced.

Samples prepared by adding different amounts of CO₂ were monitored over time for stability of the product. It suggests that at a pH of less than about 9.5 had slight fall out which occurred within one to two weeks. However, no further instability was observed over time. This fall out was black undissolved copper oxide from BCC. Samples prepared without CO₂ had slight better stability with very little undissolved copper oxide settled in the bottom.

It was difficult to determine the CO₂ absorption rate. However, the loss was very high at this slower CO₂ addition rate. This may have been due to the smaller volume used for these experiments. Tables 4 and 4A show the analytical results on K-18500 over time with different pH of different Wolman E solutions. Graph 1 shows the stability of RH651 overtime with different pH solutions. Table 4, no degradation of RH573 occurred in the tested solution. Stability of RH651 was improved almost 45% by reducing the pH from about 10.37 to about 9.50. Where as at a pH of about 9.15 stability of RH651 was increased to almost 75%.

The addition of CO₂ to the Wolman® E solution increased the stability of the moldicide in the treating solution. There was no adverse effect noted on the stability of concentrate after two months.

Red pine sapwood is treated with relative ease using CCA solutions. The application of Wolman-E solutions, however, has been shown to be more difficult. Preliminary studies using eight 3 inch red-pine 4×4 samples per treatment indicated that the addition of carbon dioxide (CO₂) or ammonium bicarbonate resulted in approximately 14% improved sapwood penetration. These initial tests used fresh solutions and a pressure schedule insufficient to provide adequate penetration (150 psi for 30 min). In commercial treatments, it is more realistic that the same solution would be used for multiple charges of wood. In addition, commercial treating schedules apply pressures up to 180 psi for an hour or longer.

In this investigation, the effects of additives and/or increased press times on the retention and penetration of Wolman-E into red pine were investigated using more realistic treating conditions. Red pine 4×4's from Biewer Lumber Company in McBain, were cut into two 4 ft sections marked “A” and “B” and end-sealed. The wood was then treated in charges containing 15 4×4's.

The 1.7% Wolman-E solution used in this investigation was previously used to treat several charges of red pine and southern yellow pine. After treatments with Wolman-E alone, this used solution was topped off with fresh solution and had 0.24% CO₂ added to it. After the CO₂ treatments, the solution was again topped off with fresh solution and 0.09% HEPA was added for two charges followed by an additional amount of HEPA, resulting in a total concentration of 0.17%. The remaining solution was discarded and fresh Wolman-E solution was made for other investigations. The new solution was used to treat two charges of SYP and one mixed charge of spruce-pine-fir (SPF). This used solution was then used in the final treatments of this scaled-up penetration study. The solution was topped off with fresh solution and had 0.45% ammonium bicarbonate added to it. A single final treatment was preformed with a 2.9% CCA solution that was previously used in another investigation.

All treatments had an initial vacuum of 25 in Hg for 15 minutes followed by a pressure of 175 psi for 60 or 120 minutes and a final vacuum of 25 in Hg for 15 minutes. The samples were analyzed by measuring solution retention and preservative penetration. Penetration measurements were made on increment cores and cross-sections removed from the middle of each sample.

There was a high variation in preservative retention and penetration within a given charge. This variation did not seem to be related to the amount of sapwood present in each 4×4 nor was it the result of moisture variations since all samples had a moisture content around 8 to 10%. Average measurements from each charge are shown in Table 5.

TABLE 5
Treatments and results with red pine 4 × 4's

| | | | | | Avg. |
|---|---|---|---|---|---|
| | Charge | Matched | Retention | % Cores | Sapwood |
| Treatment (Replicate No.) | Number¹ | Samples² | (pcf) | Passing | Pen. (%) |
| CCA 60 min | 7723 | 1A | 20 | 87 | 98 |
| CBA 60 min (1) | 7710 | 1B | 13 | 47 | 72 |
| CBA 60 min (2) | 7712 | 2A | 13 | 40 | 75 |
| CBA 60 min (3) | 7714 | 3A | 14 | 53 | 72 |
| Average | | | 13 | 47 | 73 |
| CBA 120 min (1) | 7711 | 5A | 21 | 80 | 84 |
| CBA 120 min (2) | 7713 | 6A | 16 | 33 | 67 |
| Average | | | 19 | 57 | 76 |
| CBA + 0.24% CO2 60 min (1) | 7715 | 2B | 14 | 47 | 79 |
| CBA + 0.24% CO2 60 min (2) | 7717 | 4A | 16 | 7 | 66 |
| Average | | | 15 | 27 | 73 |
| CBA + 0.24% CO2 120 min (1) | 7716 | 5B | 21 | 73 | 91 |
| CBA + 0.24% CO2 120 min (2) | 7718 | 7A | 15 | 27 | 64 |
| Average | | | 18 | 50 | 78 |
| CBA + 0.24% CO2 + 0.09% HEPA 60 min | 7719 | 3B | 13 | 47 | 69 |
| CBA + 0.24% CO2 + 0.09% HEPA 120 min | 7720 | 6B | 17 | 33 | 60 |
| CBA + 0.24% CO2 + 0.17% HEPA 60 min | 7721 | 4B | 15 | 27 | 69 |
| CBA + 0.24% CO2 + 0.17% HEPA 120 min | 7722 | 7B | 14 | 13 | 62 |
| CBA + 0.45% Ammonium Bicarbonate 60 min | 7743 | 8A | 19 | 40 | 78 |
| CBA + 0.45% Ammonium Bicarbonate 60 min | 7744 | 8B | 23 | 60 | 80 |
| Average | | | 21 | 50 | 79 |
| CBA + 0.45% Ammonium Bicarbonate 120 min | 7745 | 9A | 20 | 40 | 65 |
| CBA + 0.45% Ammonium Bicarbonate 120 min | 7746 | 9B | 23 | 20 | 88 |
| Average | | | 22 | 30 | 77 |

¹Each charge contained 15 4 × 4's.
²“A” and “B” represent end-matched samples.

A single CCA treatment, with a 60 minute press time, resulted in an average net retention of 20 pcf, 87% of the cores with acceptable penetration, and an average sapwood penetration of 98%. The average results for Wolman-E samples treated under similar conditions was a retention of 13 pcf, 47% of the cores with acceptable penetration, and a sapwood penetration of 73%.

Extension of the pressure period from 60 to 120 minutes resulted in slight retention and penetration improvements. The addition of CO₂ and the latter addition of HEPA to the same solution did not seem to improve retention or penetration for fixed press times. However, when some of the natural variation of the wood was accounted for by comparing matched samples (i.e. Groups 2A and 2B, 5A and 5B) there was a slight improvement in penetration from the addition of CO₂. After accounting for the wood, there did not seem to be any benefit from the addition of HEPA (Groups 3,4,6 and 7). Improvements from HEPA may have been seen if higher amounts were added. In addition, wood in the HEPA treatments had a blue-green indicating that the copper may be more easily leached compared to treatments without HEPA. The addition of ammonium bicarbonate resulted in noticeably higher retention and sapwood penetration values, respectively 62% and 8% for the samples treated with a 60 minute pressure period.

There are several possible explanations for the reduced benefits of additives seen in this investigation compared to the results seen in the small-scale screening tests. Higher pressures and longer press times directly resulted in improved penetration. Although these treating conditions appear to have masked penetration improvements for the difficult to treat red pine samples, the results seen here and in the preliminary work support the potential application of additives for reducing press times in more easily treated samples. Variations in wood permeability were higher in the samples used in this investigation. Except for single treatments that involved matched samples, efforts to account for permeability differences were deliberately avoided so that more realistic treating conditions would be simulated. Sap-stained samples were permitted. Thus, less permeable samples in treatments with an additive would hinder the effectiveness of the treatments. Lastly, multiple uses of the same treating solution results in successively reduced penetrating ability of the solution. This is most noticeable after the initial use of a solution. In spite of the use of a full-cell process, solution that has contacted and/ or entered previously treated wood is expected to contain wood extractives and to have been chemically modified to some extent. The reduced effectiveness of a single dose of CO₂ may also be possible.

The use of additives was previously shown to provide an improvement in sapwood penetration of about 14% under ideal conditions. This investigation also showed that the addition of CO₂ or ammonium bicarbonate resulted in improved penetration with matched samples, but this improvement was masked by the permeability variations naturally occurring in red pine sapwood. Contaminants in the used working solutions also reduce the benefits of the treatment additives. The addition of up to 0.17% HEPA did not seem to improve penetration. Increasing press time, however, did improve retention and penetration values. Although the addition of additives was not able to achieve acceptable penetration in these samples, the use of these additives may still be important to reduce treating times or assure adequate treatment of large timbers of more easily treated species.

The following study was conducted to investigate the ability to treat ponderosa pine 2×6 lumber with Wolman-E (CA-B).

Kiln dried ponderosa pine 2×6 lumber was obtained from Peterson Wood Treating (Superior, WIS.). The 8 ft boards were labeled and cut into two end-matched samples. All of the “A” ends were treated using CA-B solution containing 0.3% Cu. Three charges contained 20 boards and were processed using an initial vacuum of 25 in Hg for 10 minutes, 175 psi for 30 minutes, and a final vacuum of 25 in Hg for 10 minutes. A fourth charge was pressed for 120 minutes.

The matched “B” ends of those boards that were not completely penetrated by the treating solution were used to compare alternative treating methods. Alternative treatments included 0.735% CCA, 1.18% CCA, CA-B (0.7% Cu), CA-B (0.7% Cu +0.3% CO₂), CA-B (0.7% Cu +0.8% CO₂), and CA-B (0.7% Cu +0.8% CO₂) pressed for 120 minutes. These boards were treated 3 per charge with the same schedule used with the “A” sections. After treating, all “A” samples had increment cores removed from them to determine if solution penetration met the AWPA requirements. A cross section was removed from the center of all samples. Heart-/Sapwood and copper indicators were sprayed on the sections and they were recorded using a computer scanner.

The “A” boards treated with a 30 minute press had an average solution retention of 33 pcf. The forth charge with a 120 minute press had a retention of 40 pcf. Less than 55% of the cores in these charges passed the AWPA penetration requirement. The extended press time did not improve the percentage of passing cores.

Comparisons of matched samples showed both of the CCA treatments resulted in higher net solution retentions compared to the CA-B treatments. None of the other alternative treatments resulted in substantially increased retentions. Four of the six samples treated with the 0.735% CCA had solution completely penetrate them. But, one of these only had a light treatment in the center. All six of the samples treated with 1.18% CCA had complete penetration. Three of these, however, contained lightly treated centers. Increasing the amount of copper from 0.3 to 0.7% by itself did not seem to improve penetration of CA-B. Although the center portions remained untreated, the addition of 0.3% CO₂ improved penetration. The addition of 0.8% CO₂ led to complete penetration in four of the six samples. The remaining two samples were almost completely treated. Increasing the press time from 30 to 120 minutes along with the addition of 0.8% CO₂ also resulted in nearly complete penetration.

Some of the knots and all areas that contained pitch or resin turned lime-blue immediately after treatment. Also, white pinpoint sized balls were noted a few days after treating along the late wood of some of the cross sections. These were most likely associated with the resin canals. Besides these two observations, the remaining sample surfaces looked good.

The sapwood portion of the ponderosa pine treated in this study varied in its ability to be fully penetrated by the treating solutions. CCA solutions penetrated better than the CA-B solutions under similar treating conditions. Increasing the press time on non end-matched samples treated with CA-B alone did not seem to improve the number of cores passing the AWPA penetration requirement. The addition of CO₂ clearly enhanced the penetration of CA-B. This investigation indicated that comparable treating results may be obtained from CCA and CA-B if CO₂ is added to the CA-B concentrate.

Ponderosa Pine Treatments with CA-B

2×6's 8 ft from Peterson Wood Treating

End-matched samples: “A” treated in large cylinder, hard to treat “B” sections were treated in sets of three in a small cylinder.

Charge 7812
10 min vac @ 25 in; 30 min press @ 175; 10 min vac @ 25 in.

| | | | Retention | Penetration | Pass/ |
|---|---|---|---|---|---|
| Sample | Initial (lbs) | Final (lbs) | (pcf) | (in) | Fail |
| 1A | 7.17 | 14.61 | 32.49 | 0.288 | F |
| 2A | 6.54 | 14.79 | 36.03 | 2.5 | P |
| 3A | 6.27 | 15.34 | 39.61 | 2.5 | P |
| 4A | 7.77 | 14.01 | 27.25 | 0.192 | F |
| 5A | 6.69 | 15.13 | 36.86 | 0.638 | F |
| 6A | 7.72 | 15.42 | 33.62 | 1.161 | F |
| 7A | 6.47 | 14.73 | 36.07 | 1.38 | F |
| 8A | 6.84 | 15.31 | 36.99 | 2.5 | P |
| 9A | 7.06 | 12.86 | 25.33 | 0.493 | F |
| 10A | 6.28 | 15.71 | 41.18 | 2.5 | P |
| 11A | 6.23 | 13.7 | 32.62 | 0.945 | F |
| 12A | 7.95 | 10.46 | 10.96 | 0.984 | F |
| 13A | 7.49 | 16.09 | 37.55 | 2.5 | P |
| 14A | 7.63 | 14.74 | 31.05 | 0.412 | F |
| 15A | 6.28 | 13.26 | 30.48 | 1.031 | F |
| 16A | 6.17 | 14.38 | 35.85 | 1.043 | F |
| 17A | 6.58 | 13.63 | 30.79 | 0.726 | F |
| 18A | 6.48 | 13.49 | 30.61 | 1.239 | F |
| 19A | 6.08 | 15.67 | 41.88 | 2.5 | P |
| 20A | 5.34 | 13.2 | 34.32 | 0.886 | F |
| | | | 33.08 | | 30% Pass |

Charge 7813
10 min vac @ 25 in; 30 min press @ 175; 10 min vac @ 25 in.

| | | | Retention | Penetration | Pass/ |
|---|---|---|---|---|---|
| Sample | Initial (lbs) | Final (lbs) | (pcf) | (in) | Fail |
| 1A | 7.29 | 12.95 | 24.72 | 0.482 | F |
| 2A | 7.61 | 11.85 | 18.52 | 0.755 | F |
| 3A | 6.89 | 12.72 | 25.46 | 0.646 | F |
| 4A | 7.45 | 14.72 | 31.75 | 2.5 | P |
| 5A | 6.36 | 15.23 | 38.73 | 2.5 | P |
| 6A | 7.75 | 16.42 | 37.86 | 2.5 | P |
| 7A | 7.39 | 15.97 | 37.47 | 2.5 | P |
| 8A | 7.49 | 15.96 | 36.99 | 2.5 | P |
| 9A | 7.13 | 15.94 | 38.47 | 2.5 | P |
| 10A | 8.2 | 16.16 | 34.76 | 2.5 | P |
| 11A | 6.79 | 14.86 | 35.24 | 2.5 | P |
| 12A | 8.6 | 15.46 | 29.96 | 2.5 | P |
| 13A | 6.73 | 13.73 | 30.57 | 1.981 | F |
| 14A | 6.62 | 14.94 | 36.33 | 0.161 | F |
| 15A | 7.51 | 15.08 | 33.06 | 1.969 | F |
| 16A | 6.74 | 15.79 | 39.52 | 2.5 | P |
| 17A | 6.72 | 15.78 | 39.56 | 1.49 | F |
| 18A | 7.18 | 16.47 | 40.57 | 2.5 | P |
| 19A | 7.39 | 14.59 | 31.44 | 1.024 | F |
| 20A | 8.15 | 15.93 | 33.97 | 2.5 | P |
| | | | 33.75 | | 55% Pass |

Charge 7829
10 min vac @ 25 in; 120 min press @ 175; 10 min vac @ 25 in.

| | | | Retention | Penetration | Pass/ |
|---|---|---|---|---|---|
| Sample | Initial (lbs) | Final (lbs) | (pcf) | (in) | Fail |
| 1A | 5.79 | 15.44 | 42.14 | 0.575 | F |
| 2A | 6.68 | 16.04 | 40.87 | 6.84 | F |
| 3A | 6.57 | 15.84 | 40.48 | 2.5 | P |
| 4A | 6.49 | 15.61 | 39.83 | 3.5 | F |
| 5A | 7.35 | 16.44 | 39.69 | 2.5 | P |
| 6A | 7.21 | 16.58 | 40.92 | 2.5 | P |
| 7A | 6.12 | 15.73 | 41.97 | 2.5 | F |
| 8A | 7.45 | 15.56 | 35.41 | 0.958 | F |
| 9A | 5.77 | 16.13 | 45.24 | .745/.91 | P |
| 10A | 6.1 | 15.27 | 40.04 | 2.5 | P |
| 11A | 6.63 | 16.33 | 42.36 | 1.2/1.2 | P |
| 12A | 6.19 | 15.29 | 39.74 | 2.5 | P |
| 13A | 7.14 | 16.42 | 40.52 | 2.5 | P |
| 14A | 7.07 | 16.37 | 40.61 | 2.5 | P |
| 15A | 6.63 | 15.11 | 37.03 | .839/1.42 | F |
| 16A | 6.87 | 16.31 | 41.22 | 0.837 | F |
| 17A | 6.45 | 17.7 | 49.13 | 0.652 | F |
| 18A | 6.94 | 16.25 | 40.66 | 1.195/1.463 | F |
| 19A | 7.77 | 16.75 | 39.21 | 0.571 | F |
| 20A | 7.79 | 16.08 | 36.20 | 2.5 | P |
| | | | 40.66 | | 50% Pass |

Charge 7830
10 min vac @ 25 in; 30 min press @ 175; 10 min vac @ 25 in.

| | | | Retention | Penetration | Pass/ |
|---|---|---|---|---|---|
| Sample | Initial (lbs) | Final (lbs) | (pcf) | (in) | Fail |
| 1A | 6.99 | 13.66 | 29.13 | 1.071 | F |
| 2A | 6.87 | 16.39 | 41.57 | 2.5 | P |
| 3A | 6.55 | 14.56 | 34.98 | 2.5 | P |
| 4A | 6.82 | 14.81 | 34.89 | 2.5 | P |
| 5A | 7.46 | 12.06 | 20.09 | 1.47/2.07 | F |
| 6A | 5.73 | 13 | 31.75 | 0.808 | F |
| 7A | 5.86 | 10.56 | 20.52 | 0.202/1.421 | F |
| 8A | 6.52 | 10.8 | 18.69 | 0.168/1.224 | F |
| 9A | 5.91 | 12.36 | 28.17 | 0.379 | F |
| 10A | 5.97 | 14.23 | 36.07 | 1.201 | F |
| 11A | 6.74 | 12.91 | 26.94 | 1.042 | F |
| 12A | 6.11 | 11.7 | 24.41 | 0.569 | F |
| 13A | 5.78 | 14.3 | 37.21 | 1.324 | F |
| 14A | 6.87 | 9.72 | 12.45 | 0.282 | F |
| 15A | 6.52 | 14.01 | 32.71 | 0.336 | F |
| 16A | 6.06 | 13.08 | 30.66 | 0.898 | F |
| 17A | 6.78 | 8.723 | 8.48 | 0.58 | F |
| 18A | 6.46 | 10.11 | 15.94 | 0.77 | F |
| 19A | 6.6 | 15.29 | 37.95 | 2.5 | F |
| 20A | 6.03 | 11.08 | 22.05 | 2.5 | P |
| 21A | 5.92 | 13.98 | 35.20 | 0.738 | P |
| 22A | 7.1 | 15.43 | 36.38 | 0.461 | F |
| 23A | 7.64 | 15.92 | 36.16 | 0.801 | F |
| 24A | 6.3 | 14.5 | 35.81 | 1.852 | F |
| 25A | 7.36 | 15.93 | 37.42 | 0.421 | F |
| | | | 29.02 | | 20% Pass |

10 min vac @ 25 in; 30 min press @ 175; 10 min vac @ 25 in.

| | | | | |
|---|---|---|---|---|
| | | | Retention | |
| Sample | Initial (lbs) | Final (lbs) | (pcf) | Penetration |

CA-B (0.3% Cu)

| | | | | |
|---|---|---|---|---|
| 7830 1A | 6.99 | 13.66 | 29.13 | |
| 7830 5A | 7.46 | 12.06 | 20.09 | |
| 7830 6A | 5.73 | 13 | 31.75 | |
| 7830 7A | 5.86 | 10.56 | 20.52 | |
| 7830 8A | 6.52 | 10.8 | 18.69 | |
| 7830 9A | 5.91 | 12.36 | 28.17 | |
| Average | | | 24.72 | #DIV/0! |

CCA (0.735%)

| | | | | |
|---|---|---|---|---|
| 7830 1B | 7.01 | 16.36 | 40.83 | |
| 7830 5B | 8.02 | 16.74 | 38.08 | |
| 7830 6B | 6.16 | 15.21 | 39.52 | |
| 7830 7B | 6.22 | 13.35 | 31.14 | |
| 7830 8B | 6.57 | 14.46 | 34.45 | |
| 7830 9B | 5.63 | 14.36 | 38.12 | |
| Average | | | 37.02 | #DIV/0! |

10 min vac @ 25 in; 30 min press @ 175; 10 min vac @ 25 in.

| | | | | |
|---|---|---|---|---|
| | | | Retention | |
| Sample | Initial (lbs) | Final (lbs) | (pcf) | Penetration |

CA-B (0.3% Cu)

| | | | | |
|---|---|---|---|---|
| 7812 16A | 6.17 | 14.38 | 35.85 | |
| 7812 17A | 6.58 | 13.63 | 30.79 | |
| 7812 18A | 6.48 | 13.49 | 30.61 | |
| 7813 1A | 7.29 | 12.95 | 24.72 | |
| 7813 2A | 7.61 | 11.85 | 18.52 | |
| 7813 3A | 6.89 | 12.72 | 25.46 | |
| Average | | | 27.66 | #DIV/0! |

CCA (1.18%)

| | | | | |
|---|---|---|---|---|
| 7812 16B | 5.96 | 15.05 | 39.69 | |
| 7812 17B | 6.14 | 15.77 | 42.05 | |
| 7812 18B | 6.37 | 15.75 | 40.96 | |
| 7813 1B | 6.96 | 15.59 | 37.69 | |
| 7813 2B | 6.93 | 15.39 | 36.94 | |
| 7813 3B | 6.65 | 15.31 | 37.82 | |
| Average | | | 39.19 | #DIV/0! |

10 min vac @ 25 in; 30 min press @ 175; 10 min vac @ 25 in.

| | | | | |
|---|---|---|---|---|
| | | | Retention | |
| Sample | Initial (lbs) | Final (lbs) | (pcf) | Penetration |

CA-B (0.3% Cu)

| | | | | |
|---|---|---|---|---|
| 7830 11A | 6.74 | 12.91 | 26.94 | |
| 7830 12A | 6.11 | 11.7 | 24.41 | |
| 7830 13A | 5.78 | 14.3 | 37.21 | |
| 7830 14A | 6.87 | 9.72 | 12.45 | |
| 7830 15A | 6.52 | 14.01 | 32.71 | |
| 7830 17A | 6.78 | 8.723 | 8.48 | |
| Average | | | 23.70 | #DIV/0! |

CA-B (0.7% Cu)

| | | | | |
|---|---|---|---|---|
| 7830 11B | 6.5 | 12.31 | 25.37 | |
| 7830 12B | 6.62 | 13.42 | 29.69 | |
| 7830 13B | 5.69 | 13.95 | 36.07 | |
| 7830 14B | 7.3 | 9.22 | 8.38 | |
| 7830 15B | 6.88 | 12.31 | 23.71 | |
| 7830 17B | 6.93 | 9.66 | 11.92 | |
| Average | | | 22.53 | #DIV/0! |

10 min vac @ 25 in; 30 min press @ 175; 10 min vac @ 25 in.

| | | | | |
|---|---|---|---|---|
| | | | Retention | |
| Sample | Initial (lbs) | Final (lbs) | (pcf) | Penetration |

CA-B (0.3% Cu)

| | | | | |
|---|---|---|---|---|
| 7812 6A | 7.75 | 16.42 | 37.86 | |
| 7812 7A | 7.39 | 15.97 | 37.47 | |
| 7812 9A | 7.13 | 15.94 | 38.47 | |
| 7812 11A | 6.79 | 14.86 | 35.24 | |
| 7812 14A | 6.62 | 14.94 | 36.33 | |
| 7812 15A | 7.51 | 15.08 | 33.06 | |
| Average | | | 36.40 | #DIV/0! |

CA-B (0.7% Cu + 0.3% CO2)

| | | | | |
|---|---|---|---|---|
| 7812 6B | 7.24 | 12.91 | 24.76 | |
| 7812 7B | 6.89 | 14.79 | 34.50 | |
| 7812 9B | 6.63 | 12.02 | 23.54 | |
| 7812 11B | 6.38 | 13.73 | 32.10 | |
| 7812 14B | 7.35 | 13.72 | 27.82 | |
| 7812 15B | 6.26 | 12.09 | 25.46 | |
| Average | | | 28.03 | #DIV/0! |

10 min vac @ 25 in; 30 min press @ 175; 10 min vac @ 25 in.

| | | | | |
|---|---|---|---|---|
| | | | Retention | |
| Sample | Initial (lbs) | Final (lbs) | (pcf) | Penetration |

CA-B (0.3% Cu)

| | | | | |
|---|---|---|---|---|
| 7813 13A | 6.73 | 13.73 | 30.57 | |
| 7813 14A | 6.62 | 14.94 | 36.33 | |
| 7813 15A | 7.51 | 15.08 | 33.06 | |
| 7813 17A | 6.72 | 15.78 | 39.56 | |
| 7813 19A | 7.39 | 14.59 | 31.44 | |
| 7813 20A | 8.15 | 15.93 | 33.97 | |
| Average | | | 34.16 | #DIV/0! |

CA-B (0.7% Cu + 0.8% CO2)

| | | | | |
|---|---|---|---|---|
| 7813 13B | 6.7 | 14.45 | 33.84 | |
| 7813 14B | 6.3 | 14.18 | 34.41 | |
| 7813 15B | 7.03 | 15.73 | 37.99 | |
| 7813 17B | 6.68 | 16.35 | 42.23 | |
| 7813 19B | 7.32 | 16.08 | 38.25 | |
| 7813 20B | 8.15 | 16.85 | 37.99 | |
| Average | | | 37.45 | #DIV/0! |

10 min vac @ 25 in; 120 min press @ 175; 10 min vac @ 25 in.

| | | | | |
|---|---|---|---|---|
| | | | Retention | |
| Sample | Initial (lbs) | Final (lbs) | (pcf) | Penetration |

CA-B (0.3% Cu)

| | | | | |
|---|---|---|---|---|
| 7829 8A | 7.45 | 15.56 | 35.41 | |
| 7829 15A | 6.63 | 15.11 | 37.03 | |
| 7829 16A | 6.87 | 16.31 | 41.22 | |
| 7829 17A | 6.45 | 17.7 | 49.13 | |
| 7829 18A | 6.94 | 16.25 | 40.66 | |
| 7829 19A | 7.77 | 16.75 | 39.21 | |
| Average | | | 40.44 | #DIV/0! |

CA-B (0.7% Cu + 0.8% CO2)

| | | | | |
|---|---|---|---|---|
| 7829 8B | 8.13 | 15.33 | 31.44 | |
| 7829 15B | 6.72 | 14.38 | 33.45 | |
| 7829 16B | 6.87 | 16.89 | 43.76 | |
| 7829 17B | 6.49 | 15.91 | 41.14 | |
| 7829 18B | 7.5 | 16.96 | 41.31 | |
| 7829 19B | 6.9 | 16.73 | 42.93 | |
| Average | | | 39.00 | #DIV/0! |

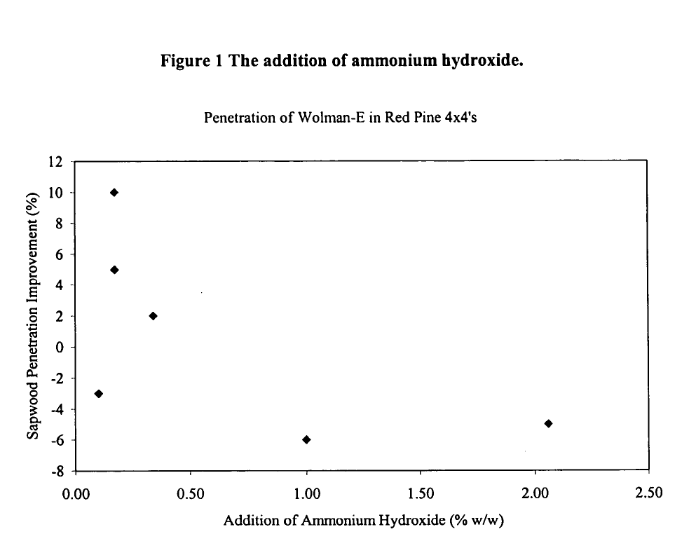

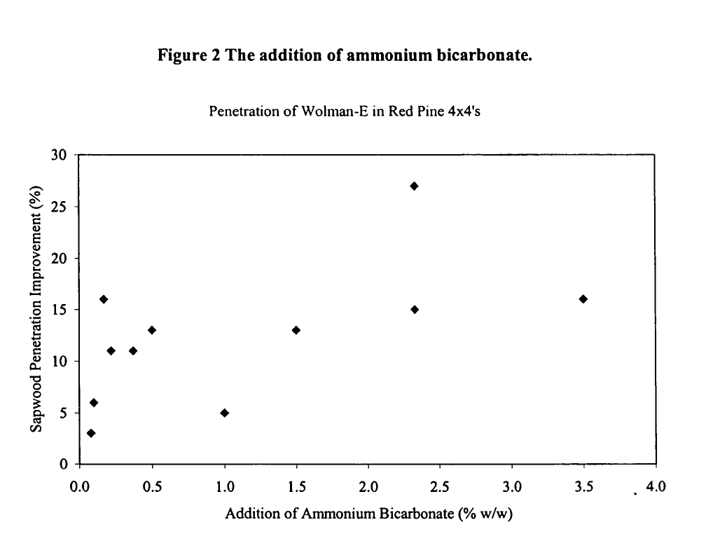

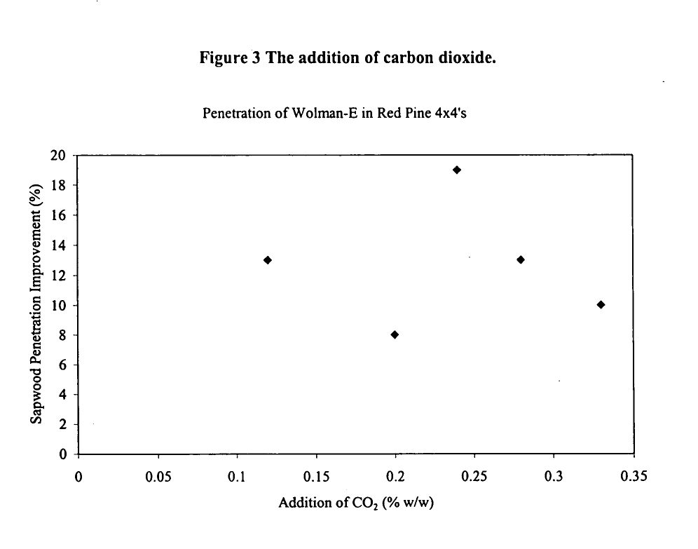

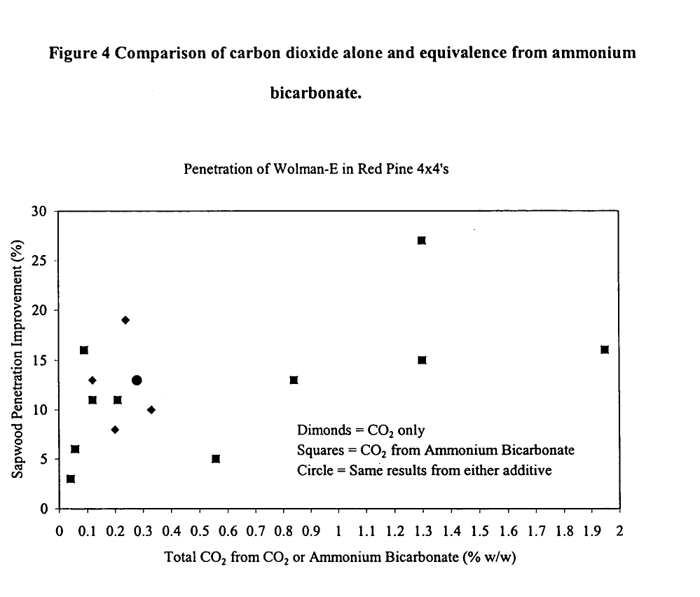

The following is a summary of work on the improvement of Wolman-E penetration into red pine 4×4's.
The results showed mixed results for the addition of ammonium hydroxide (NH₄OH). Three of the four treatments having less than 1% NH₄OH resulted in sapwood penetration improvements. The treatment with 2% NH₄OH had reduced penetration (FIG. 1). Therefore, the use of NH₄OH is not recommended for applications with red pine.
Increasing the amount of ammonium bicarbonate (NH₅CO₃) from 0.08 to about 0.2% resulted in increased sapwood penetration from 3 to approximately 14%. Additional NH₅CO₃ did not have a significant influence on penetration (FIG. 2). The single treatment having a 27% penetration increase seems to be an anomaly.
The addition of carbon dioxide (CO₂) improved penetration. The addition of 0.12% CO₂ resulted in a 13% improvement in sapwood penetration. Adding more CO₂ showed mixed results and most likely will not result in consistent benefits (FIG. 3). It is important to note that the maximum amount of CO₂ added was limited to approximately 0.4% by experimental methods. Higher additions may be possible indirectly through the addition of NH₅CO₃.
The extent of benefit from the addition of ammonia (NH₃) from NH₄OH or NH₅CO₃ is not clear. It is possible that NH₃ from the NH₄OH helps penetration, but the hydroxide radical (OH⁻) released in solution hinders penetration. Three of the four treatments below 1% NH4OH indicated that NH₃ may be a beneficial additive. On the contrary, the NH₃ in NH₅CO₃ did not seem to assist with penetration beyond the benefits from the CO₂. Evidence for this is shown in FIG. 4 where penetrations were similar for equivalent CO₂ concentrations with and with out NH₃.

The above work showed that the optimal additives for Wolman-E containing 0.35% copper were 0.2% NH₅CO₃ and 0.12% CO₂. Because ground contact treatments are likely to contain approximately 0.8% copper, higher levels of additives will be needed. It is proposed that we use 0.46% NH₅CO₃ and 0.27% CO₂. Commercial treatments show that a schedule of 175 psi for 60 minutes is needed to treat red pine 4×4's. Therefore, the proposed schedule will be an initial vacuum of 24 in Hg for 15 min followed by 60 min at 180 psi and 15 min at 24 in Hg. If the treatments are inadequate, the pressure period will be extended to 120 min.

In summary, the following trials will be conducted:

| Solution | Additive | Press time (min) |
|---|---|---|
| Wolman-E (0.8% Cu) | none | 60 |
| Wolman-E (0.8% Cu) | 0.46% AB | 60 |
| Wolman-E (0.8% Cu) | 0.27% CO₂ | 60 |
| Wolman-E (0.8% Cu) | none | 120 |
| Wolman-E (0.8% Cu) | 0.46% AB | 120 |
| Wolman-E (0.8% Cu) | 0.27% CO₂ | 120 |

One additional alternative treatment was tested in order to improve CA-B penetration into ponderosa pine sapwood. This treatment used CA-B concentrate with enough CO₂ added to bring the pH to 9.6. A total of about 5% CO₂ was added to the concentrate. The treating solution thus contained about 0.4% CO₂. More CO₂ can be added to the concentrate.

The CO₂ treatment resulted in slightly higher preservative retention and, in most cases, increased penetration. Only one of the six matched boards did not show improved penetration. Complete penetration resulted in four of the six samples. The following table and figure show these results.

These results confirmed earlier findings showing the benefits of adding CO₂ to the CA-B concentrate. The addition of CO₂ reduces the concentrate pH and results in a treating solution that penetrates better and may allow the use of K18500.

[image]

10 min vac @ 25 in; 30 min press @ 175; 10 min vac @ 25 in.

| | | | | |
|---|---|---|---|---|
| | | | Retention | |
| Sample | Initial (lbs) | Final (lbs) | (pcf) | Penetration |

CA-B (0.3% Cu)

| | | | | |
|---|---|---|---|---|
| 7830 18A | 6.46 | 10.11 | 15.94 | |
| 7830 20A | 6.03 | 11.08 | 22.05 | |
| 7830 21A | 5.92 | 13.98 | 35.20 | |
| 7830 22A | 7.1 | 15.43 | 36.38 | |
| 7830 24A | 6.3 | 14.5 | 35.81 | |
| 7830 25A | 7.36 | 15.93 | 37.42 | |
| Average | | | 30.47 | #DIV/0! |

CA-B (0.7% Cu + 0.4% CO2 (conc. pH = 9.6))

| | | | | |
|---|---|---|---|---|
| 7830 18B | 4.471 | 6.9 | 16.99 | |
| 7830 20B | 4.334 | 7.38 | 21.30 | |
| 7830 21B | 6.635 | 15.64 | 39.32 | |
| 7830 22B | 7.48 | 16.95 | 41.35 | |
| 7830 24B | 7.565 | 16.48 | 38.93 | |
| 7830 25B | 7.188 | 13.64 | 28.17 | |
| Average | | | 31.01 | #DIV/0! |

The present invention deals with a method of performing an impregnating treatment on a resin-containing wood substrate using a fluid comprising the steps of:

(i) providing the wood substrate;

(ii) contacting the wood substrate with said fluid; and

(iii) maintaining contact between the wood substrate and fluid for a time period sufficient to obtain the desired penetration, wherein the fluid is a wood protectant with carbon dioxide added thereto.

The process may also be advantageous for treating hardwood, such as beechwood, to obtain a uniform dying through the complete interior thereof.

Due to physical and chemical properties as well as availability and costs and lacking toxicity and non-flammability, carbon dioxide, possibly together with a minor amount of a solubility promotor such as an alcohol or ketone, is the preferred fluid used state when the purpose is to impregnate wood by means of an organic fungicide or insecticide.

Thus, a preferred embodiment of the method is characterized in that to increase the delivering ability of the fluid carbon dioxide is added to the wood protectant.

Experiments have shown that by adding carbon dioxide to fungicides by the method of the invention the fungicides can be dispersed evenly in the wood in concentrations sufficient for the desired preservation.

The process of the invention is not restricted to biocide impregnation of wood substrate, but is also suitable for impregnation of wood substrate with one or more of the species of the groups: colorants, fireproofing agents, and other agents imparting specific qualities, e.g. strength-improving agents such as agents which are polymerized in situ after having been dispersed within the wood structure.

1. A method of performing an impregnating treatment on a resin-containing wood substrate using a fluid comprising the steps of:
(i) providing the wood substrate;
(ii) contacting the wood substrate with said fluid; and
(iii) maintaining contact between the wood substrate and the fluid for a time period sufficient to obtain the desired penetration wherein the fluid is a wood protectant with carbon dioxide added thereto.

2. A method according to claim 1, characterized in that wood from a coniferous tree is impregnated using a wood preserving agent comprising at least one species selected from fungicides and insecticides.

3. A method according to claim 2, characterized in that the wood from a coniferous tree is selected from the group consisting of spruce (pica), fir (abies, pseudotsuga), hemlock (tsuga), pine (pinus) and larch (larix).

4. A method according to claim 1, characterized in that the wood protectant is a copper amine.

5. A method according to claim 1, characterized in that resinous wood from a coniferous tree is impregnated with at least one organic biocide having carbon dioxide added thereto as delivering medium, that the contact is maintained for at least about ten (10) minutes at a pressure of at least about five (5) bar.

6. A method according to claim 5, characterized in that the at least one biocide is propiconazole or tebuconazole or both.

7. A method according to claim 5, characterized in that the biocide is dissolved in an organic solvent before being combined with the carbon dioxide.

8. A method according to claim 1, characterized in that the wood substrate is additionally impregnated with one or more of the group consisting of colorants, fireproofing agents, and strength-improving agents.

9. In the method for forming lignocellulosic-based composite products which are resistant to insect and fungal attack, the improvement which comprises incorporating a pesticide or fungicide with the addition of carbon dioxide thereto prior to forming said composite product.

10. The method according to claim 1 in which said carbon dioxide amount is in the range of from about 0.10 to about 1.0 percent by weight of protectant.

11. The method according to claim 14 in which said carbon dioxide amount is in the range of from about 0.20 to about 0.80 percent by weight of protectant.

12. The method according to claim 1 in which the ratio of wood protectant to carbon dioxide is from about 1:0.05 to about 1:0.5.

13. The method according to claim 1 in which the ratio of wood protectant to carbon dioxide is from about 1:0.1 to about 1:1.

14. Composite product according to claim 1 in which said lignocellulosic material is wood.

15. A composite lignocellulosic-based product having resistance to insect and fungal attack, produced by the method according to claim 1.
